(19) United States
(12) Patent Application Publication
(10) Pub. No.: US 2005/0254246 A1
(43) Pub. Date: Nov. 17, 2005

(54) Illuminating device with heat-dissipating function

(76) Inventor: Kun-Lieh Huang, Taoyuan City (TW)

Correspondence Address: PRO-TECHTOR INTERNATIONAL SERVICES, 20775 Norada Court, Saratoga, CA, 95070-3018, US

(21) Appl. No.: 10/953,256

(22) Filed: Sep. 28, 2004

(30) Foreign Application Priority Data
May 12, 2004 (TW) 93113321

(51) Int. Cl. F21S 2/00; F21V 29/00; F21V 15/00

(52) U.S. Cl. 362/362; 362/227

(57) ABSTRACT

An illuminating device includes a housing and an illuminating module mounted in the housing. The housing defines a sealed space that includes a light-transmitting plane on an end thereof. The illuminating module includes a circuit board and lighting elements mounted on the circuit board. The housing includes a housing body and a cap. The housing body includes an open first end, and the cap is mounted to and covers the open first end of the housing body, with the circuit board of the illuminating device being sandwiched between an engaging area between the cap and the housing body. Thus, the heat generated by the illuminating module can be conducted to the housing, providing improved heat-dissipating effect.

### BACKGROUND OF THE INVENTION

1. Field of the Invention

The present invention relates to an illuminating device. In particular, the present invention relates to an illuminating device with a heat-dissipating function.

2. Description of the Related Art

FIGS. 1 and 2 of the drawings illustrate a conventional illuminating device 1 providing illumination and photographing functions. The illuminating device 1 comprises a housing 11 comprised of a housing body 111 and a cap 112, an illuminating module 12, a photographing module 13, and a fixing plate 14. The illuminating module 12 includes a circuit board 121 and a plurality of light-emitting diodes (LEDs) 122. The photographing module 13 includes a circuit board 131 and a lens 132 mounted in a central area of the circuit board 131 and extending through the circuit board 121 of the illuminating module 12. As illustrated in FIG. 2, in assembly, the circuit board 121 of the illuminating module 12 is screwed to two copper pegs 141 on a side of the fixing plate 14, which, in turn, is screwed to an inner periphery of the housing body 111. The cap 112 is then threadedly engaged with the housing body 111. The illuminating module 12 may provide additional light in the night or a dark place, allowing photographing operation.

The illuminating device 1 can be used outdoors. To provide a waterproof effect, the housing 11 is designed to provide a sealed waterproof space with a side effect of having a poor heat dissipation, as air in the sealed waterproof space could not be communicated with atmosphere while the LEDs 122 and other electric elements such as driver transistors, limiting resistors, etc generate considerable heat during operation. In particular, the generated heat transmitted to the circuit board 121 via the pins of the LEDs 122 or the other electric elements could not be effectively dissipated, as the sealed space of the housing 11 and the circuit board 121 made of glass fiber could not provide a satisfactory heat conduction effect. Only a small portion of the heat can be transmitted via the copper pegs 141 to the fixing plate 14. The overall heat-dissipating efficiency is poor, resulting in high temperature when the illuminating module 12 operates. This shortens the life of the LEDs 122. Even worse, the LEDs 122 may burn out in a short time and thus shorten the life of the photographing module 13. Further, the poor heat-dissipating efficiency also limits the number of LEDs 122 (at best, 12-18 LEDs are allowed on the circuit board 12), failing to provide sufficient illumination for the photographing module 13 when desired. The obtained pictures may be unclear. Further, mounting the illuminating module 12 onto the fixing plate 14 by screws is costly and time-consuming.

### SUMMARY OF THE INVENTION

An object of the present invention is to provide an illuminating device with a satisfactory heat-dissipating effect.

Another object of the present invention is to provide an illuminating device with a heat-dissipating effect that can be assembled easily.

In accordance with a first aspect of the present invention, an illuminating device comprises a housing and an illuminating module mounted in the housing. The housing defines a sealed space that includes a light-transmitting plane on an end thereof. The illuminating module includes a circuit board and a plurality of lighting elements mounted on the circuit board. The circuit board of the illuminating module is positioned at the inner periphery of the housing.

The housing includes a housing body and a cap. The housing body includes an open first end, and the cap is mounted to and covers the open first end of the housing body, with the circuit board of the illuminating device being sandwiched between an engaging area between the cap and the housing body.

In an embodiment of the invention, the open first end of the housing body includes an outer threading, and the cap includes an inner threading for threadedly engaging with the outer threading of the housing body. The circuit board of the illuminating module includes a diameter greater than an inner diameter of the housing body and not greater than an outer diameter of the housing body, allowing the circuit board to be mounted to an end face of the open first end of the housing body.

The end face of the open first end of the housing body may include a first engaging member, and the circuit board may include a second engaging member for engaging with the first engaging member. In an embodiment of the invention, the first engaging member is a peg and the second engaging member is a notch.

In another embodiment of the invention, the open first end of the housing body includes an inner threading and a flange, and the cap includes an outer threading for threadedly engaging with the inner threading of the housing body, with the circuit board of the illuminating module being positioned by the flange.

The illuminating device may further include a photographing module mounted in the housing. The illuminating device may further include a fixing member for fixing the photographing module in the housing. The photographing module includes a circuit board and a lens mounted in a center of the circuit board. Screws are extended through the circuit board of the photographing module and the fixing member into the housing. The fixing member may be obtained by means of cutting a tube made of extrusion such that a thickness of the fixing member matches a length of the lens.

The lighting elements may be light-emitting diodes. The illuminating device may further include a fan mounted in the housing.

In an embodiment of the invention, the circuit board of the illuminating module includes a first metal film formed on a side thereof and not in contact with the lighting elements. The circuit board of the illuminating module further including a second metal film formed on the first metal film and not in contact with the lighting elements. The second metal film may be made of tin or nickel.

In a further embodiment of the invention, the open first end of the housing body of the housing includes an annular groove in an inner periphery thereof for receiving and thus positioning the circuit board of the illuminating module. A retainer ring is mounted in the cap and the retainer ring includes an outer threading for threadedly engaging with an inner threading of the cap, with the circuit bard of the illuminating module being sandwiched between the retainer ring and an end face of the open first end of the housing body of the housing.

The open first end of the housing body includes a shoulder, with a plurality of positioning pins projecting from the shoulder. The fixing member includes a plurality of positioning holes through which the positioning pins extend. The fixing member further includes a plurality of through-holes, the housing body includes a plurality of mounting pegs each having a screw hole, and the circuit board of the photographing module includes a plurality of through-holes. A plurality of screws are provided, with each crew extending through an associated through-hole of the circuit board of the photographing module and through an associated through-hole of the fixing member into the screw hole of an associated mounting peg of the housing body.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of a conventional illuminating device.

FIG. 2 is a side view, partly sectioned, of the conventional illuminating device.

FIG. 3 is an exploded side view, partly sectioned, of an illuminating device in accordance with the present invention.

FIG. 4 is a side view, partly sectioned, of the illuminating device in accordance with the present invention.

FIG. 5 is a perspective view of a fixing member of the illuminating device in accordance with the present invention.

FIG. 6 is a front view of an illuminating module of the illuminating device in accordance with the present invention.

FIG. 7 is a rear view of the illuminating module of the illuminating device in accordance with the present invention.

FIG. 8 is a side view, partly sectioned, of a modified embodiment of the illuminating device in accordance with the present invention.

FIG. 9 is a side view, partly sectioned, of another modified embodiment of the illuminating device in accordance with the present invention.

FIG. 10 is an exploded side view, partly sectioned, of a portion of the modified embodiment in FIG. 9.

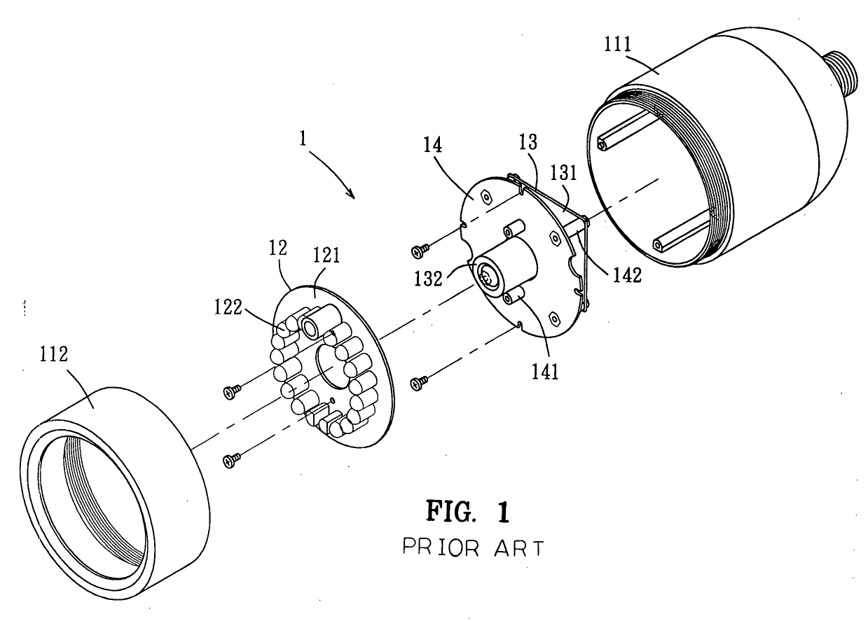

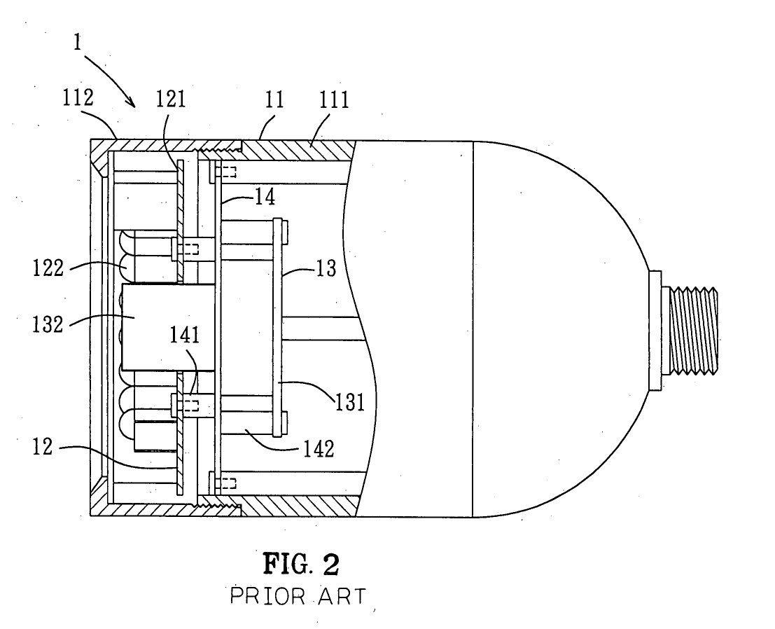

### DETAILED DESCRIPTION OF THE PREFERRED EMBODIMENT

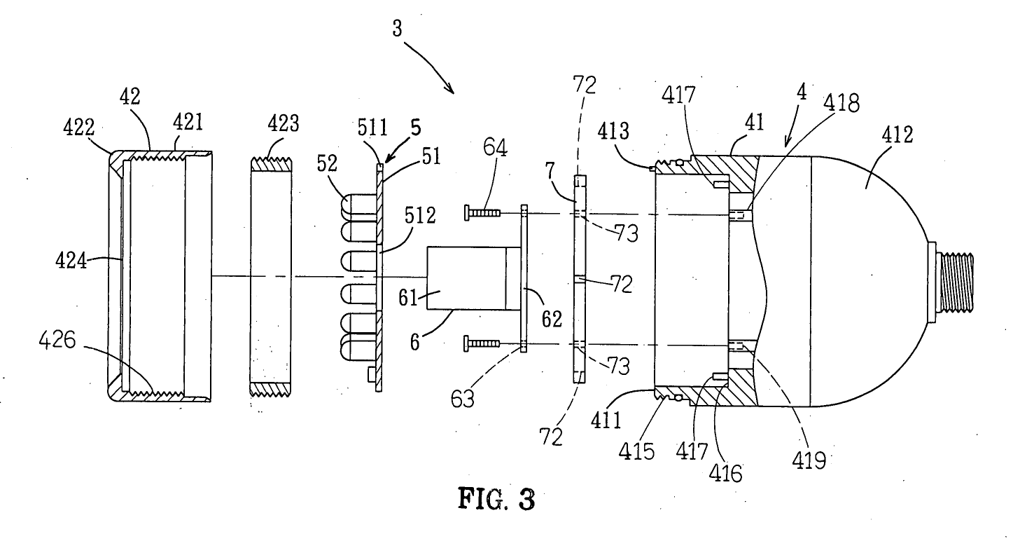

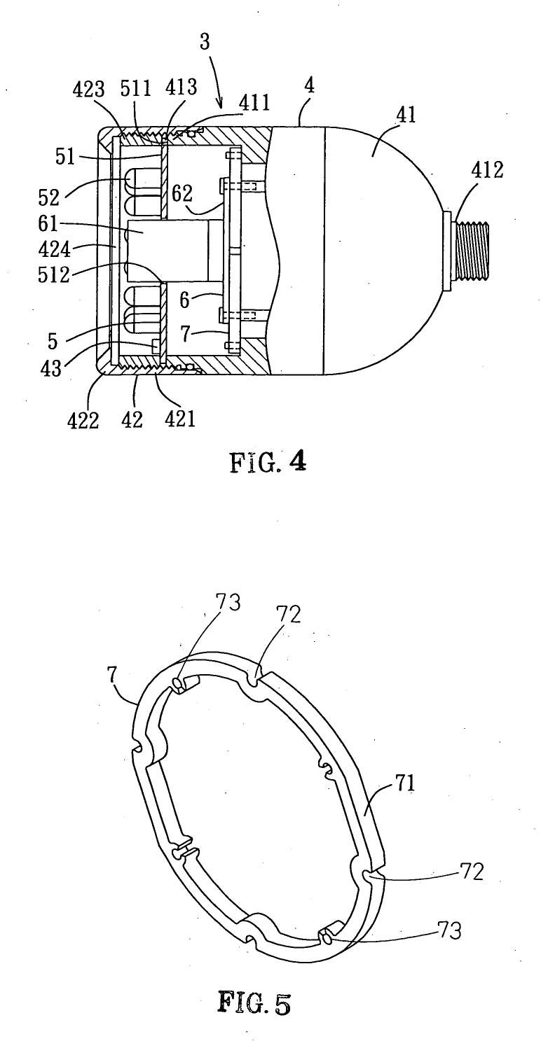

Referring to FIGS. 3 and 4, an illuminating device 3 in accordance with the present invention comprises a housing 4, an illuminating module 5, and a photographing module 6. The housing 4 include a housing body 41 and a cap 42. The housing body 41 is substantially cylindrical and includes an open first end 411 and a second end 412 tapered to form a smaller opening through which wires (not labeled) for the illuminating module 5 and the photographing module 6 are extended. The open first end 411 of the housing body 41 includes an outer threading 415, and a peg 413 is formed on an end face of the open first end 411.

The cap 42 is also substantially cylindrical and sized to match the open first end 411 of the housing body 41. In particular, the cap 42 includes a first end 421, a second end 422, and an inner threading 426 for threadedly engaging with the outer threading 415 of the housing body 41. A glass 424 is fixed by a retainer ring 423 to an inner side of the second end 422 of the cap 42, allowing light to pass through the glass 424 (or light-transmitting plane). Thus, when the cap 42 is engaged with the housing body 41, a waterproof housing 4 with a sealed space is provided.

The illuminating module 5 includes a circuit board 51 with a control circuit including driver transistors, limiting resistors, etc. Also mounted on the circuit board 51 are a plurality of lighting elements 52. The circuit board 51 has a diameter greater than an inner diameter of the open first end 411 of the housing body 411 yet not greater than an outer diameter of the open first end 411 of the housing body 411. As illustrated in FIG. 4, a circumferential edge of the circuit board 51 is sandwiched between the open first end 411 of the housing body 41 and the retainer ring 423 mounted in the cap 42. Thus, the illuminating module 5 is physically connected to the housing 4 such that the heat generated by the illuminating module 5 can be conducted to the housing 4 for dissipating heat by a larger area.

In this embodiment, the lighting elements 52 are light-emitting diodes (LEDs) that are controlled by the circuit board 51. To prevent the circuit board 51 from turning together with the cap 42 during mounting of the cap 42 to the housing body 41, the circuit board 51 includes a notch 511 with which the peg 413 of the housing body 41 is engaged. Further, the circuit board 51 includes a central hole 512 through which a lens 61 of the photographing module 6 extends.

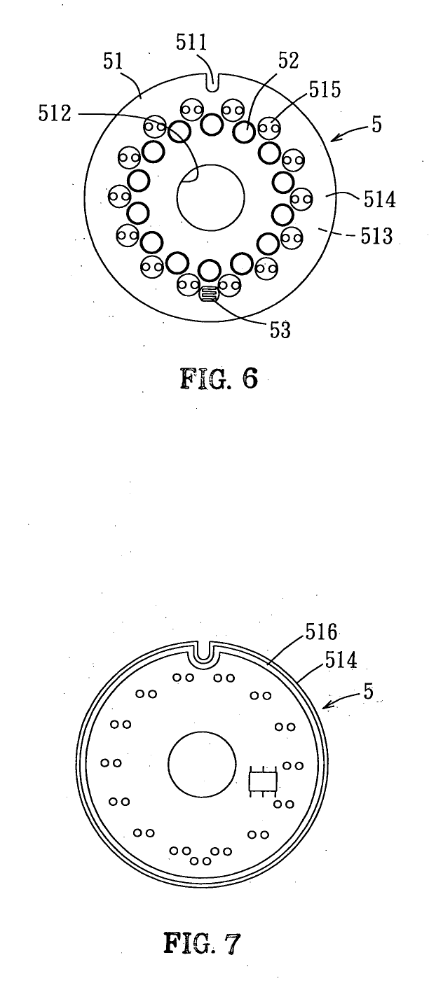

When the ambient light intensity is insufficient for the photographing module 6 to proceed with photographing, the illuminating module 5 is turned on to provide additional light for obtaining sufficient brightness. The illuminating module 5 may further include a light sensor 53 (FIG. 6) for detecting ambient light intensity and sending a signal relating to information of ambient light intensity to the circuit board 51. The circuit board 51 turns the lighting elements 52 on when the ambient light intensity is discriminated as below a threshold value.

The photographing module 6 includes a circuit board 62 with a control circuit, with the lens 61 being mounted to a center of the circuit board 62. The illuminating module 5 and the photographing module 6 are connected by wires (not shown) for transmitting power and video signals.

To position the photographing module 6, the illuminating device 3 further includes a fixing member 7. As illustrated in FIG. 5, the fixing member 7 is not greater than the inner diameter of the open first end 411 of the housing body 41. Further, the open first end 411 of the housing body 41 includes a shoulder 416, with a plurality of positioning pins 417 projecting from the shoulder 416. The fixing member 7 is substantially annular and includes a plurality of positioning holes 72 through which the positioning pins 417 extend. The fixing member 7 further includes a plurality of through-holes 73, and a plurality of mounting pegs 418 are formed in the housing body 41. The circuit board 62 of the photographing module 6 also includes a plurality of through-holes 63. A plurality of screws 64 are provided, with each screw 64 extending through an associated through-hole 63 of the circuit board 62 of the photographing module 6 and through an associated through-hole 73 of the fixing member 7 into a screw hole 419 of an associated mounting peg 418 of the housing body 41. Thus, the photographing module 6 is fixed in the housing body 41, and the heat generated by the photographing module 6 can be conducted to the housing body 41 for heat dissipation.

As well know in the art, the length of the lens 61 may be varied in response to different focuses. The lens 61 may be spaced from the glass 424 such that the light beams from the lighting elements 52 may be reflected and scattered into the lens 61, causing adverse affect to the photographing quality. In this embodiment, the fixing member 7 is obtained by means of cutting a tube made of extrusion such that the thickness of the fixing member 7 may be varied from, e.g., 3 mm, 4 mm, 5 mm, matching the length of the lens 61. This allows the lens 61 to be in contact with the lens 424, reducing reflection and scattering of light beams. The tube may include two planar faces (see faces 71 in FIG. 5) to allow easy clamping by a clamping device during cutting of the tube. Alternatively, the circuit board 62 of the photographing module 6 can be directly engaged with the fixing member 7 by self-tapping threading.

The fixing member 7 is annular in this embodiment. Nevertheless, the fixing member 7 can be any other shape, such as circular.

In assembly, as illustrated in FIG. 4, the circuit board 61 of the photographing module 6 is attached to the fixing member 7, which, in turn, is mounted inside the housing module 4. The circuit board 51 of the illuminating module 5 is mounted on the photographing module 6, with the lens 61 of the photographing module 6 extending through the central hole 512 of the circuit board 51 and with the peg 413 of the housing body 41 extending through the notch 51 of the circuit board 51 of the illuminating module 5. The circuit board 51 is thus placed on the end face of the open first end 411 of the housing body 41. Next, the glass 424 is placed into the cap 42 and positioned by the retainer ring 423. The cap 42 is then mounted to the housing body 41, with the circuit board 51 being sandwiched between the retainer ring 423 and the end face of the open first end 411 of the housing body 41.

By such an arrangement, the circuit board 51 of the illuminating module 5 that generates considerable heat during operation is in direct contact with the housing 4 and thus allows the heat to be conducted to the housing 4 for dissipation to the environment via a larger heat-dissipating area provided by the housing 4. The overall heat-dissipating effect is improved. Further, the circuit board 51 of the illuminating module 5 is sandwiched between the housing body 41 of the housing 4 and the retainer ring 423 in the cap 42 (see FIG. 4) without being screwed to the fixing member 7. The assembling time and cost as well as the required material are saved.

To increase the heat-dissipating effect, the illuminating module 5 may include a metal film 513 (FIG. 6) formed on a side of the circuit board 51 that faces the glass 424. A mounting area 515 on which the lighting elements 52 are mounted is free of the metal film 513. In this embodiment, the circuit board 51 is a dual layer circuit board, with a wiring layer of copper foil acting as the metal film 513. Another metal film 514 with excellent reflection effect may be electroplated on an outer face of the metal film 513. The metal film 514 is preferably made of tin and not located in the mounting area 515.

The metal films 513 and 514 allow rapid and uniform conduction of heat to the housing 4, further improving the heat-dissipating efficiency. As illustrated in FIG. 7, electric elements such as driver transistors, limiting resistors, etc as well as wiring are mounted on the other side of the circuit board 51 of the illuminating module 5 and surrounded by an insulating layer 516 to avoid external interference and short circuit resulting from thunderbolt. Thus, the metal films 513 and 514 may assist in heat dissipation under normal operation. Further, the metal film 514 may increase the reflective effect of the lighting elements. In this case, the metal film 514 may be made of nickel.

As readily apparent to one skilled in the art, the assembling relationship between the housing 4 and the illuminating module 5 can be modified to meet the design need.

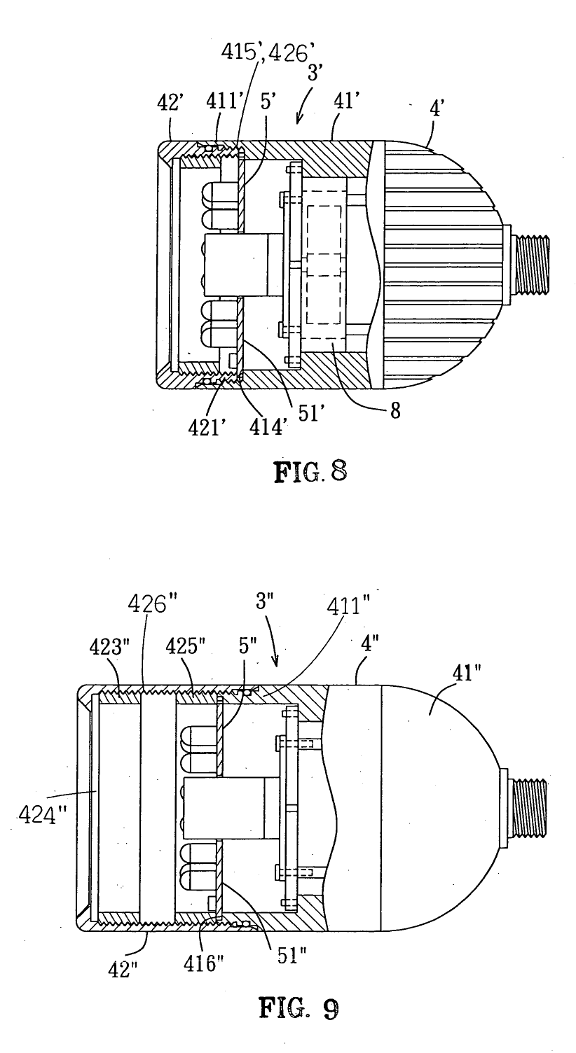

FIG. 8 illustrates a modified embodiment of the illuminating device (now designated by 3′) of the invention, wherein the open first end 411′ of the housing body 41′ of the housing 4′ includes an inner threading 415′, and the cap 42′ includes an outer threading 426′ for threadedly engaging with the inner threading 415′ of the housing body 41′. Further, the open first end 411′ of the housing body 41′ of the housing 4′ includes a flange 414′ for positioning the circuit board 51′ of the illuminating module 5′. The first end 411′ of the housing body 41′ is located around the first end 421′ of the cap 42′, and the circuit board 51′ of the illuminating module 5′ is sandwiched between the housing body 41′ and the cap 42′ to assist in heat dissipation. Further, a fan 8 can be mounted in the illuminating device 3′ for improving air circulation, providing improved heat-dissipating efficiency. Further, the housing 4′ may include recessed patterns in an outer periphery thereof to increase the overall area for heat dissipation.

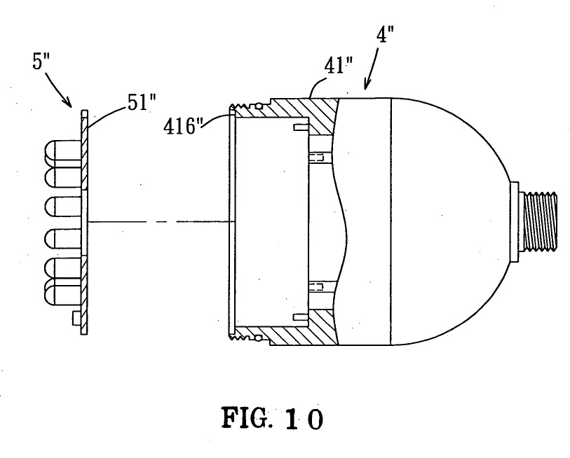

FIGS. 9 and 10 illustrate another modified embodiment of the illuminating device 3″ of the invention, wherein in addition to the retainer ring 423″ for pressing against the glass 424″, an additional retainer ring 425″ is mounted in the cap 42″ and threadedly engaged with an inner threading 426″ of the cap 42″. The open first end 411″ of the housing body 41″ of the housing 4″ includes an annular groove 416″ in an inner periphery thereof for receiving and thus positioning the circuit board 51″ of the illuminating module 5″, with the circuit bard 51″ of the illuminating module 5″ being sandwiched between the retainer ring 425″ and an end face of the open first end 411″ of the housing body 41″ of the housing 4″. The retainer ring 425″ increases the contact area of the circuit board 51″, providing improved heat-dissipating effect.

Since the heat-dissipating efficiency is significantly improved, the number of lighting elements used in the illuminating device 3, 3′, 3″ can be increased up to, e.g., twenty-eight (28). The illumination can be improved, allowing obtaining of clear pictures even in the night or a dark place.

Although the illuminating devices in the above embodiments are illustrated and described to include a photographing module, it is noted that the photographing module can be omitted such that the illuminating devices provide a single function of illumination.

Although specific embodiments have been illustrated and described, numerous modifications and variations are still possible without departing from the essence of the invention. The scope of the invention is limited by the accompanying claims.

1. An illuminating device comprising:
a housing defining a sealed space that includes a light-transmitting plane on an end thereof, the housing including an inner periphery; and
an illuminating module mounted in the housing, the illuminating module including a circuit board and a plurality of lighting elements mounted on the circuit board, the circuit board of the illuminating module being positioned at the inner periphery of the housing.

2. The illuminating device as claimed in claim 1, with the housing including a housing body and a cap, the housing body including an open first end, the cap being mounted to and covering the open first end of the housing body, the circuit board of the illuminating device being sandwiched between an engaging area between the cap and the housing body.

3. The illuminating device as claimed in claim 2, with the open first end of the housing body includes an outer threading, the cap including an inner threading for threadedly engaging with the outer threading of the housing body, the circuit board of the illuminating module including a diameter greater than an inner diameter of the housing body and not greater than an outer diameter of the housing body, allowing the circuit board to be mounted to an end face of the open first end of the housing body.

4. The illuminating device as claimed in claim 3, with the end face of the open first end of the housing body including a first engaging member, with the circuit board including a second engaging member for engaging with the first engaging member.

5. The illuminating device as claimed in claim 4, with the first engaging member being a peg and with the second engaging member being a notch.

6. The illuminating device as claimed in claim 2, with the open first end of the housing body including an inner threading and a flange, with the cap including an outer threading for threadedly engaging with the inner threading of the housing body, and with the circuit board of the illuminating module being positioned by the flange.

7. The illuminating device as claimed in claim 2, with the illuminating device further including a photographing module mounted in the housing.

8. The illuminating device as claimed in claim 7, with the illuminating device further including a fixing member for fixing the photographing module in the housing.

9. The illuminating device as claimed in claim 8, with the photographing module including a circuit board and a lens mounted in a center of the circuit board, further including screws extending through the circuit board of the photographing module and the fixing member into the housing.

10. The illuminating device as claimed in claim 9, with the fixing member being obtained by means of cutting a tube made of extrusion such that a thickness of the fixing member matches a length of the lens.

11. The illuminating device as claimed in claim 1, with the lighting elements being light-emitting diodes.

12. The illuminating device as claimed in claim 1, with the circuit board of the illuminating module including a first metal film formed on a side thereof and not in contact with the lighting elements.

13. The illuminating device as claimed in claim 12, with the circuit board of the illuminating module further including a second metal film formed on the first metal film and not in contact with the lighting elements.

14. The illuminating device as claimed in claim 1, with the illuminating device further including a fan mounted in the housing.

15. The illuminating device as claimed in claim 2, with the open first end of the housing body of the housing including an annular groove in an inner periphery thereof for receiving and thus positioning the circuit board of the illuminating module.

16. The illuminating device as claimed in claim 15, with the illuminating device further including a retainer ring mounted in the cap, the retainer ring including an outer threading, the cap including an inner threading for threadedly engaging with the retainer ring, with the circuit bard of the illuminating module being sandwiched between the retainer ring and an end face of the open first end of the housing body of the housing.

17. The illuminating device as claimed in claim 9, with the open first end of the housing body including a shoulder, with a plurality of positioning pins projecting from the shoulder, the fixing member including a plurality of positioning holes through which the positioning pins extend.

18. The illuminating device as claimed in claim 17, with the fixing member further including a plurality of through-holes, with the housing body including a plurality of mounting pegs each having a screw hole, with the circuit board of the photographing module including a plurality of through-holes, further including a plurality of screws, with each said screw extending through an associated one of the through-holes of the circuit board of the photographing module and through an associated one of the through-holes of the fixing member into the screw hole of an associated one of the mounting pegs of the housing body.

19. The illuminating device as claimed in claim 13, with the second metal film being made of tin.

20. The illuminating device as claimed in claim 13, with the second metal film being made of nickel.
